(19) United States
(12) Patent Application Publication
(10) Pub. No.: US 2017/0312157 A1
(43) Pub. Date: Nov. 2, 2017

(54) Urinal

(71) Applicant: Anthony Solazzo, Watchung, NJ (US)

(72) Inventor: Anthony Solazzo, Watchung, NJ (US)

(21) Appl. No.: 15/498,644

(22) Filed: Apr. 27, 2017

Related U.S. Application Data
(60) Provisional application No. 62/328,946, filed on Apr. 28, 2016.

(51) Int. Cl. A61G 9/00; F16K 15/02; A47K 11/12

(52) U.S. Cl. CPC A61G 9/006; A47K 11/12; F16K 15/021

(57) ABSTRACT

The urinal is provided with a valve assembly that includes a first member mounted in the neck and a second member movably mounted in the first member to move between an open position relative to the first member to allow passage of urine therebetween for filling of the container and a closed position relative to the first member to block passage of urine therebetween and to contain the contents of the container.

This application claims the benefit of Provisional Patent Application 62/328,946, filed Apr. 28, 2016.

This application relates to a urinal. More particularly, this invention relates to a urinal for use by bed-confined males.

Portable male urinals for use by patients confined to bed or people who otherwise have a need for a urinal are well known in the art. Typically, such urinals include a urine receiving reservoir for holding and/or storing urine and a spout extending from the reservoir. The spout includes an inlet through which the urine is received.

As described in U.S. Pat. No. 6,021,529, a long recognized problem associated with portable male urinals is resisting backflow of the urine following use of the urinal or resisting the undesirable spillage of urine due to, for example, mishandling of the urinal. Backflow or spillage can result in the urine coming into contact with the patient or the bed which in turn can cause unsanitary health conditions and result in the increased risk for further medical problems, such as infections. In addition, the workload of caretakers is increased due to the need for cleaning the patient and/or the bed following the spillage of urine thereon. Mishandling of the urinal may be a result of the bedridden patient leaving the urinal, for example, on the bed following use and then inadvertently contacting the urinal and causing spillage therefrom.

Numerous attempts have been made at improving portable male urinals to overcome such problems. In some cases, anti-backflow devices have been proposed such as described in U.S. Pat. Nos. 5,839,123 and 5,953,763.

It is an object of the invention to provide a urinal with a valve assembly for preventing backflow.

It is another object of the invention to provide a urinal that is comfortable for use by a male patient.

It is another object of the invention to prevent inadvertent spillage from a urinal used by a bedridden male.

Briefly, the invention provides a urinal comprised of a container having an elongated body defining a urine-receiving chamber and including a neck at one end communicating with the chamber and having an opening at one end and a valve assembly mounted in the opening of the neck.

The valve assembly is constructed to allow filling of the container with urine from a bed-confined male in the usual manner and to close off the container, for example, to prevent spillage of the collected urine from the container.

In accordance with the invention, the valve assembly includes a first member mounted in the opening of the neck of the container and a second member mounted in the first member to move between an open position to allow filling of the container and a closed position to contain the contents of the container.

In one embodiment, the first member of the valve assembly has a peripheral wall with at least one slot in one end thereof facing towards the chamber of the container and the second member has a peripheral wall with at least one slot in one end for movement between a first position aligned with the slot of the first member to allow passage of urine into the chamber and a second position out of alignment with the slot of the first member to block passage of urine into and out of the chamber.

In this embodiment, the second member of the valve assembly is rotatable in the first member. The second member of the valve assembly is axially moveable relative to the first member during relative rotation therebetween to move the peripheral wall of the second member into sliding engagement with the peripheral wall of the first member with the slot of the second member in the second position thereof thereby sealing the slot of the second member against the peripheral wall of the first member.

The first member of the valve assembly has an internally threaded annular portion integral with the peripheral wall thereof for threading onto the neck of the container and the second member of the valve assembly has an internally threaded annular portion integral with the peripheral wall thereof for threading onto the peripheral wall of the first member.

In a second embodiment, the first member has a peripheral wall of conical shape and an outlet at one end of the wall and the second member has a peripheral wall of conical shape with at least one slot therein disposed in spaced radial relation to the peripheral wall of the first member in the open position to allow passage of urine through the slot and the outlet and disposed in mating engagement with the peripheral wall of the first member in the closed position to block passage of urine through the slot and the outlet.

In this latter embodiment, the second member is also rotatable in the first member and axially moveable relative to the first member during relative rotation therebetween.

In addition, the second member has a projection at one end of the peripheral wall thereof for fitting into the outlet in mating relation to close the outlet in the closed position.

The urinal is also provided with an indicator for sensing when the chamber of the container is full. In one embodiment, the indicator is in the form of an indicator light mounted on container with one end projecting into the chamber for contact with a volume of urine in the chamber. When in operation, the indicator light is responsive to contact with a predetermined volume of urine in the chamber to emit a light indicative of the chamber becoming full.

Typically, the body of the container has a flat bottom surface and the neck extends angularly of the bottom surface. In addition, body has an enlarged portion with a flat wall opposite for neck for resting on a support surface in an upright condition when the urinal is not in use.

The container may also be provided with has an upstanding ring on the body for manual grasping of container by a user for pulling the container into a proper position for use. Alternatively, the ring may be incorporated in a handle that extends along the length of the container.

In use, after placement of the urinal with the valve assembly in the open position between the legs of a user, filling of the urinal may begin. Once filled, the urinal may be removed by an attendant and the valve assembly closed by moving the second member into the closed position to prevent spillage of urine from the container.

After filling, a user may turn the valve assembly into the closed position to avoid backflow of the urine while awaiting removal by an attendant.

These and other advantages of the invention will become more apparent form the following detailed description taken in conjunction with the accompanying drawings wherein:

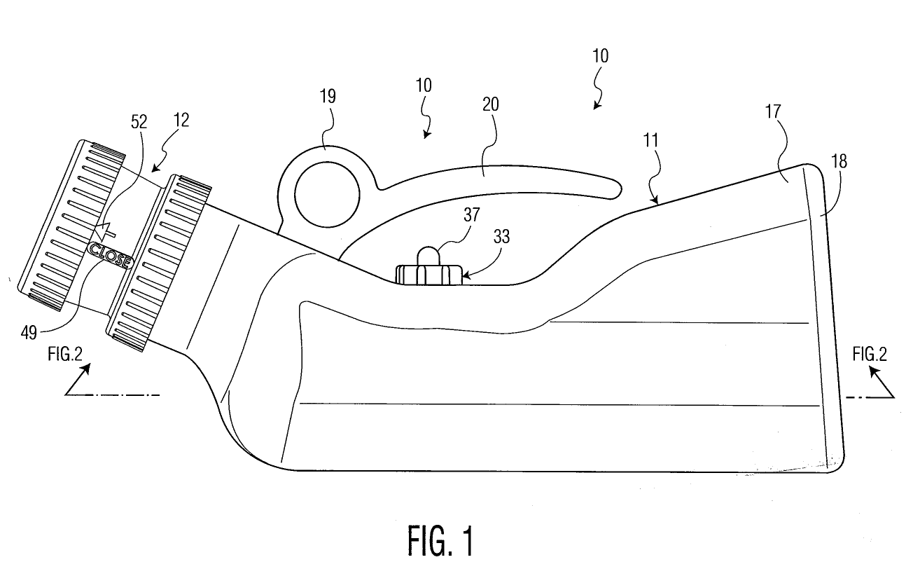

FIG. 1 illustrates a side view of urinal with an indicator light constructed in accordance with the invention;

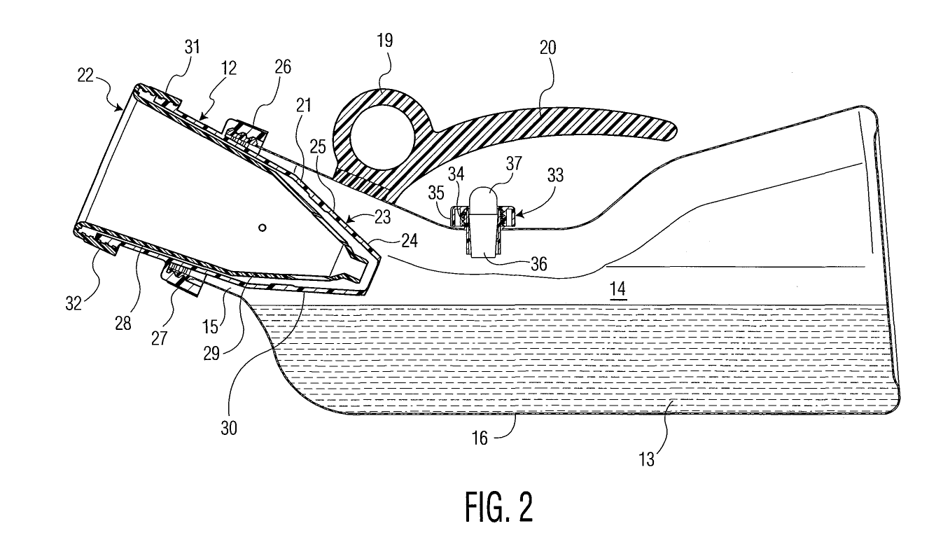

FIG. 2 illustrates a partial cross-section view of the urinal of FIG. 1;

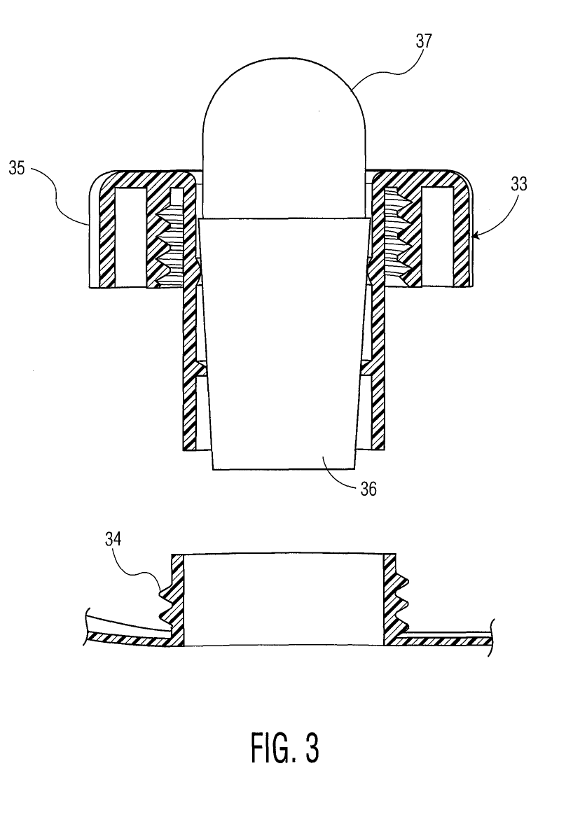

FIG. 3 illustrates an exploded view of the indicator light in accordance with the invention;

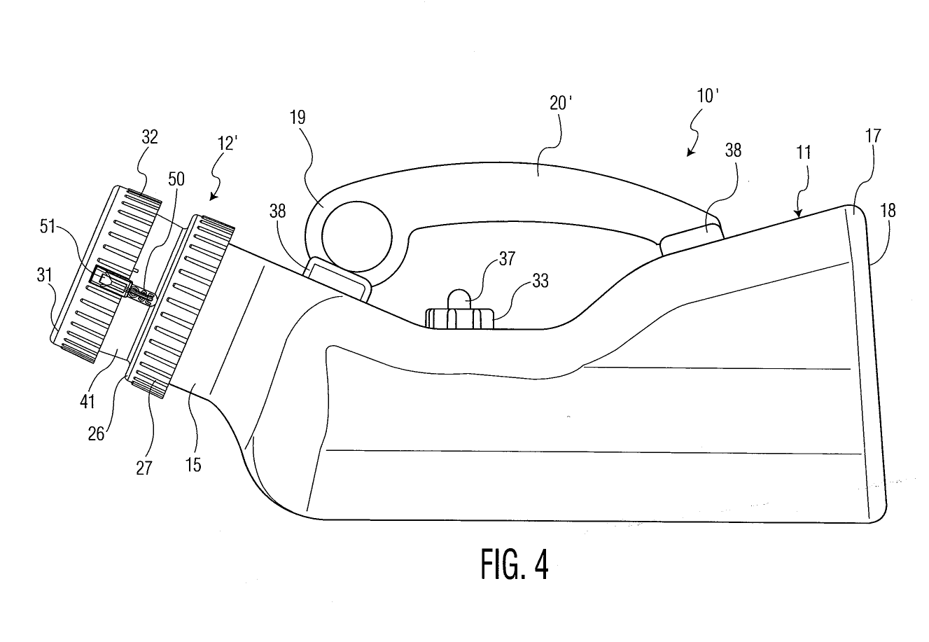

FIG. 4 illustrates a side view of a second embodiment of a urinal in accordance with the invention;

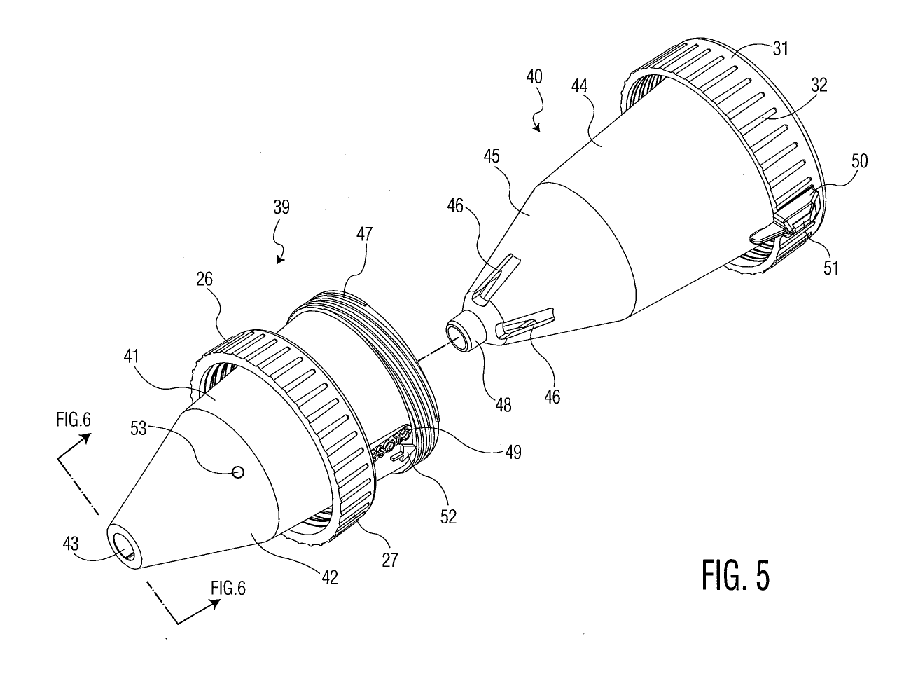

FIG. 5 illustrates an exploded view of a valve assembly employed on the embodiment of FIG. 4; and

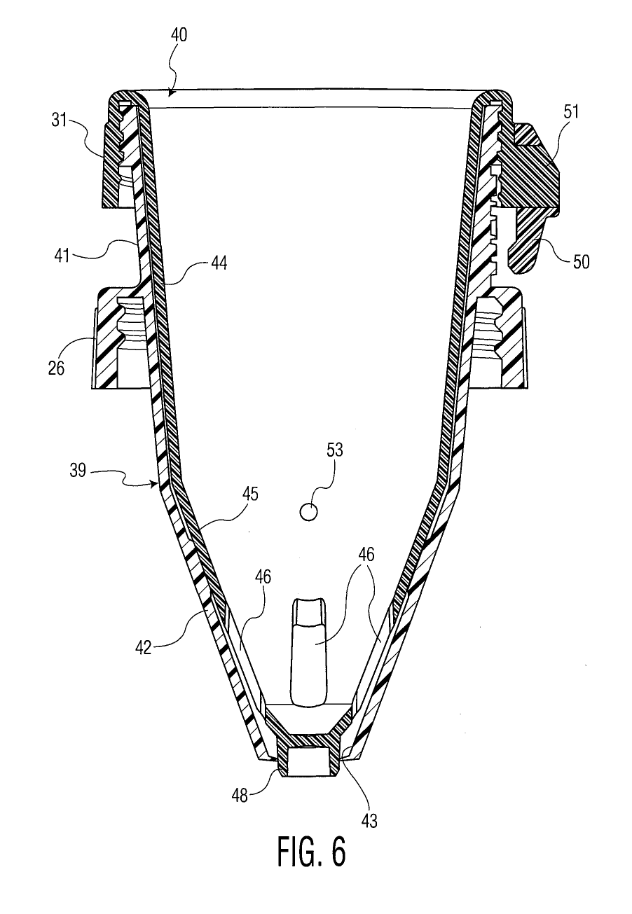

FIG. 6 illustrates a cross-sectional view of the valve assembly of FIG. 5.

Referring to FIG. 1, the urinal 10 includes a container 11 and a valve assembly 12 in one end of the container 11.

Referring to FIG. 2, the container 11 is typically made of plastic and has an elongated body 13 defining a urine-receiving chamber 14 and includes a neck 15 at one end communicating with the chamber 14. The neck 15 is of tubular cross-section to define an opening into the chamber 14.

The body 13 has a flat bottom surface 16 and the neck 15 extends angularly of bottom surface 16. The shape of the container 11 is such as to fit comfortably between the legs of a bed-confined patient, typically, a male. To this end, the flat bottom surface 16 of the container 11 allows the container 11 to lie in a horizontal plane as viewed or approximately so.

The body 13 also has an enlarged portion 17 with a flat wall 18 opposite the neck 15 for resting on a support surface (not shown) in an upright condition. Thus, when the urinal 10 is not in use, the urinal 10 may be set aside on a table or the like.

The container 11 may also be provided with an upstanding ring 19 on the body 13 for manual grasping of container 11 by a user to locate the urinal in an appropriate position for the collection of urine. As indicated, the ring 19 may be integral with a handle 20 secured to the body 13.

Referring to FIG. 2, the valve assembly 12 is mounted in the opening of the neck 15 of the container 11 and is constructed to be removable from the container 11, for example, for purposes of emptying the contents of the container 11.

The valve assembly 12 includes a first member 21 mounted in the opening of the neck 15 and a second member 22 rotatably mounted in the first member 21.

The first member 21 is of hollow tubular shape with a peripheral wall 23 with a conical portion 24 having at least one slot 25, for example three slots, in one end facing towards the chamber 14. The conical portion 24 is located within the neck 15 and the opposite end of the wall 23 extends outwardly of the neck 15.

The first member 21 also has an internally threaded annular portion 26 integral with the peripheral wall 23 for threading onto an external thread on the neck 15 of the container 11. The annular portion 26 is typically provided with a knurled periphery 27 for manual gripping.

The second member 22 is of hollow tubular shape with a peripheral wall 28 with a conical portion 29 having a like number of slots 30 as the first member 21 in one end for movement between a first position (open) aligned with the slot(s) 25 of the first member 21 to allow passage of urine into the chamber 14 of the container 11 and a second position (closed) out of alignment with the slot(s) 25 of the first member 21 to block passage of urine into and out of the chamber 14.

The conical portion 29 of the second member 22 is disposed within the conical portion 24 of the first member 21 and the opposite end of the wall 28 extends outwardly coextensively to the wall 23.

The second member 22 has an internally threaded annular portion 31 integral with the peripheral wall 28 and threaded onto an external thread on the end of the peripheral wall 23 of the first member 21. The annular portion 31 is typically provided with a knurled periphery 32 for manual gripping and has a rounded contour at the entry end to the valve assembly 12 to avoid sharp edges that might otherwise cause discomfort to a user.

The second member 22 is sized to slide into the first member 21 with the respective conical portions 29, 24 being circumferentially spaced from each other in the “open” position to allow passage of urine and in sliding contact with each other in the “closed” position to block passage of urine.

In use, the second member 22 is axially moveable relative to the first member 21 during relative rotation therebetween to move the conical portion 29 of the peripheral wall 28 of the second member 22 into sliding engagement with the conical portion 24 of the peripheral wall 23 of the first member 21 with the slot(s) 25 of the second member 22 in the second position thereof thereby sealing the slot(s) 25 of the second member 22 against the conical portion 24 of the peripheral wall 23 of the first member 21.

Referring to FIGS. 2 and 3, an indicator light 33 is mounted in a port 34 on the container 11 and has one end projecting into the chamber 14 for contact with a predetermined volume or level of urine in the chamber 14. The indicator light 33 functions to be responsive to contact with the volume of urine in the chamber 14 to emit a light indicative thereof.

As indicated in FIG. 3, the indicator light 33 has a housing 35 threaded onto the port 34, a contact 36 that depends into the container 11 and a light 37 for emitting a light in response to the contact 36 touching a level of urine in the container 11.

In use, after placement of the urinal 10 with the valve assembly 12 in the open position between the legs of a user, filling of the urinal 10 may begin. Once filled, the urinal 10 may be removed by an attendant and the valve assembly 12 may be closed by rotating the second member into the closed position to prevent spillage of urine from the container 11.

As the rounded contour at the entry end to the valve assembly avoids sharp edges, use of the urinal allows for a more comfortable use by a male patient.

Referring to FIG. 4, wherein like reference characters indicate like parts as above, the urinal 10′ is provided with a modified valve assembly 12′ and a handle 20′ that is secured to the container 11 at two ends. The handle 20′ may be made integral with the container 11 or may be made as a separate member that can be fitted to the container 11, for example, via a slide fit in a suitable slot-forming buttons 38 on the container 12.

As illustrated, the handle 20′ extends along the length of the container 11 with a ring 19 incorporated therein.

Referring to FIGS. 5 and 6, the valve assembly 12′ includes two members 39, 40 that are movable relative to each other to move between an open position relative to each other to allow passage of urine therebetween for filling of the container 11 and a closed position (FIG. 6) relative to each other to block passage of urine therebetween and to contain the contents of the container.

The outer member 39 of the valve assembly 12′ is of hollow tubular shape with a peripheral wall 41 with a conical portion 42 that is located within the neck 15 (see FIG. 4). In addition, the outer member 39 has an outlet 43 at one end of the wall 41 and the opposite end of the wall 41 extends outwardly of the neck 15 (see FIG. 4).

As above, the outer member 39 also has an internally threaded annular portion 26 integral with the peripheral wall 41 for threading onto an external thread (not shown) on the neck 15 of the container 11. The annular portion 26 is typically provided with a knurled periphery 27 for manual gripping.

The inner member 40 of the valve assembly 12′ is of hollow tubular shape with a peripheral wall 44 with a conical portion 45 having a number of slots 46, e.g. four, in one end. The peripheral wall 44 is disposed in spaced radial relation to the peripheral wall 41 of the outer member 39 in the open position of the valve assembly 12′ to allow passage of urine through one or more slots 46 into the outer member 39 and through the outlet 43 thereof into the container 11.

The peripheral wall 44 of the inner member 40 is disposed in mating engagement with the peripheral wall 41 of the outer member 39 in the closed position of the valve assembly to block passage of urine through the slot 46 and the outlet 43.

As above, the conical portion 45 of the inner member 40 is disposed within the conical portion 42 of the outer member 21 and the opposite end of the wall 44 extends outwardly coextensively to the wall 41.

The inner member 40 has an internally threaded annular portion 31 integral with the peripheral wall 44 and threaded onto an external thread 47 on the end of the peripheral wall 41 of the outer member 39. The annular portion 31 is typically provided with a knurled periphery 32 for manual gripping and has a rounded contour at the entry end to the valve assembly 12 to avoid sharp edges that might otherwise cause discomfort to a user.

In use, the inner member 40 is axially moveable relative to the outer member 39 during relative rotation therebetween to move the conical portion 45 of the peripheral wall 44 of the inner member 40 relative to the conical portion 42 of the peripheral wall 41 of the outer member 39. When in the open position of the valve assembly 12′, the conical portions 45, 42 are radially spaced from each other. When in the closed position of the valve assembly 12′, the conical portions 45, 42 are mated against each other with the slots 46 of the inner member 40 sealed against the conical portion 42 of the outer member 39.

Referring to FIG. 5, the inner member 40 has a projection 48 at one end of the peripheral wall 44 thereof for fitting into the outlet 43 of the outer member 39 in mating relation to close the outlet 43 when in the closed position of the valve assembly.

The valve assembly 12′ may be readily removed from the container 11 for purposes of emptying the contents of the container 11 and/or for cleaning of the container 11 by simply unthreading the valve assembly 12′ from the container 11. Thereafter, the valve assembly 12′ may be readily mounted on the container 11 by threading of the valve assembly onto the container.

In order to indicate to a user that the urinal is in an open position or a closed position, the outer member 39 is provided with indicia 49 on the peripheral wall 41 adjacent the external thread 47 indicative of each of the open position and the closed position while the inner member 40 is provided with an indicator 50 for movement into alignment with the respective indicia 49 to indicate the position of inner member 40 relative to the outer member 39.

Referring to FIGS. 5 and 6, the indicator 50 is in the form of a finger that is mounted on an outstanding block 51 on the annular portion 31 of the inner member 40.

Further, in order to reduce the risk of leakage, the external thread 47 may be a double thread and an indicia in the form of an arrow 52 may be provided on the peripheral wall 41 of the outer member 39, to indicate to an attendant where to place the indicator 50 when threading the inner member 40 onto the thread 47 on the outer member 39 after emptying and cleaning the urinal 10′.

Still further, in order to vent the container 11 during filling, a vent opening 53, as shown in FIGS. 5 and 6, is provided in the peripheral wall 41 of the outer member 39.

The invention thus provides a urinal with a valve assembly for preventing backflow and inadvertent spillage from a urinal used by a bedridden male.

The invention also provides a urinal that is comfortable for use by a male patient.

The invention also provides a portal urinal that reduces the risk of inadvertent spillage due to, for example, mishandling of the urinal, and reduces the workload of caretakers by eliminating or reducing the need for cleaning a patient and/or a bed following inadvertent spillage of urine thereon.

What is claimed is:

1. A urinal comprising
a container having an elongated body defining a urine-receiving chamber and including a neck at one end communicating with said chamber and having an opening at one end thereof; and
a valve assembly mounted in said opening of said neck of said container, said valve assembly including a first member mounted in said opening of said neck and a second member movably mounted in said first member to move between an open position relative to said first member to allow passage of urine therebetween for filling of the container and a closed position relative to said first member to block passage of urine therebetween and contain the contents of the container.

2. A urinal as set forth in claim 1 wherein said first member has a peripheral wall with at least one slot in one end thereof facing towards said chamber and said second member has a peripheral wall with at least one slot in one end thereof for movement between a first position aligned with said slot of said first member to allow passage of urine into said chamber in said open position of said valve assembly and a second position out of alignment with said slot of said first member to block passage of urine into and out of said chamber in said closed position of said valve assembly.

3. A urinal as set forth in claim 2 wherein said second member is rotatable in said first member and axially moveable relative to said first member during relative rotation therebetween to move said peripheral wall of said second member into sliding engagement with said peripheral wall of said first member with said slot of said second member in said second position thereof thereby sealing said slot of said second member against said peripheral wall of said first member.

4. A urinal as set forth in claim 1 wherein said first member has a peripheral wall of conical shape and an outlet at one end of said wall; and said second member has a peripheral wall of conical shape with at least one slot therein disposed in spaced radial relation to said peripheral wall of said first member in said open position to allow passage of urine through said slot and said outlet and disposed in mating engagement with said peripheral wall of said first member in said closed position to block passage of urine through said slot and said outlet.

5. A urinal as set forth in claim 4 wherein said second member is rotatable in said first member and axially moveable relative to said first member during relative rotation therebetween.

6. A urinal as set forth in claim 5 wherein said second member has a projection at one end of said peripheral wall thereof for fitting into said outlet in mating relation to close said outlet in said closed position.

7. A urinal as set forth in claim 1 wherein said first member of said valve assembly has an internally threaded annular portion integral with said peripheral wall thereof and threaded onto said neck of said container and said second member of said valve assembly has an internally threaded annular portion integral with said peripheral wall thereof and threaded onto said peripheral wall of said first member.

8. A urinal as set forth in claim 7 further comprising indicia on said first member indicative of said open position and said closed position and an indicator on said second member for movement into alignment with said indicia to indicate the position of said second member relative to said first member.

9. A urinal as set forth in claim 1 further comprising an indicator light mounted on said container and having one end projecting into said chamber for contact with a volume of urine in said chamber, said indicator light being responsive to contact with the volume of urine in said chamber to emit a light indicative thereof.

10. A urinal as set forth in claim 1 wherein said body has an enlarged portion with a flat wall opposite said neck for resting on a support surface in an upright condition and a flat bottom surface with said neck extending angularly of said bottom surface.

11. A urinal as set forth in claim 1 wherein said container has a handle extending along the length thereof with a ring incorporated therein.

12. A valve assembly as set forth in claim 1 further comprising a vent opening in said peripheral wall of said first member.

13. A valve assembly for a urinal comprising
a first member having a peripheral wall with at least one slot in one end thereof; and
a second member movably mounted in said first member, said second member having a peripheral wall with at least one slot in one end thereof for movement between a first position aligned with said slot of said first member to allow passage of urine therethrough and a second position out of alignment with said slot of said first member to block passage of urine therethrough.

14. A valve assembly as set forth in claim 13 wherein said second member is rotatable in said first member and is axially moveable relative to said first member during relative rotation therebetween to move said peripheral wall of said second member into sliding engagement with said peripheral wall of said first member with said slot of said second member in said second position thereof thereby sealing said slot thereof against said peripheral wall of said first member.

15. A valve assembly as set forth in claim 14 wherein said first member has an internally threaded annular portion integral with said peripheral wall thereof for threading onto a urinal and said second member has an internally threaded annular portion integral with said peripheral wall thereof and threaded onto said peripheral wall of said first member.

16. A valve assembly for a urinal comprising
a first member having a peripheral wall of conical shape and an outlet at one end of said wall; and
a second member movably mounted in said first member to move between an open position and a closed position, said second member having a peripheral wall of conical shape with at least one slot therein disposed in spaced radial relation to said peripheral wall of said first member in said open position to allow passage of urine through said slot and said outlet and disposed in mating engagement with said peripheral wall of said first member in said closed position to block passage of urine through said slot and said outlet.

17. A valve assembly as set forth in claim 16 wherein said second member is rotatable in said first member and is axially moveable relative to said first member during relative rotation therebetween.

18. A valve assembly as set forth in claim 17 wherein said second member has a projection at one end of said peripheral wall for fitting into said outlet in mating relation to close said outlet in said closed position.

19. A valve assembly as set forth in claim 16 further comprising indicia on said first member indicative of said open position and said closed position and an indicator on said second member for movement into alignment with said indicia to indicate the position of said second member relative to said first member.

20. A valve assembly as set forth in claim 16 further comprising a vent opening in said peripheral wall of said first member.
